(19) United States
(12) Patent Application Publication
(10) Pub. No.: US 2006/0208504 A1
(43) Pub. Date: Sep. 21, 2006

(54) Motor vehicle lock and holding device for a motor vehicle safety means

(75) Inventor: Checrallah Kachouh, Dortmund (DE)

Correspondence Address: ROBERTS, MLOTKOWSKI & HOBBES, P. O. BOX 10064, MCLEAN, VA, 22102-8064, US

(73) Assignee: Brose Schliesssysteme GmbH & Co. KG, Wuppertal (DE)

(21) Appl. No.: 11/376,717

(22) Filed: Mar. 16, 2006

(30) Foreign Application Priority Data
Mar. 16, 2005 (DE) 20 2005 004 390.7

(51) Int. Cl. E05C 3/06

(52) U.S. Cl. 292/216

(57) ABSTRACT

A motor vehicle lock and a holding device for a motor vehicle safety device having a component which can be shifted out of the neutral position into an action position are both provided with a latch, a ratchet arrangement and a release-free mechanism which is pretensioned against a stop. The latch has at least an open position which releases the component, a main latching position, and an overtravel area located on an opposite side of the main latching position from the open position. The ratchet arrangement has at least one holding position and a release position. A free-running lever is pivotable around a pivot axis to activate the release-free mechanism, and the free-running lever is coupled to the latch such that passing of the release-free mechanism is associated with pivoting of the free-running lever against its pretensioning.

### BACKGROUND OF THE INVENTION

1. Field of the Invention

The invention relates to a motor vehicle lock having a latch and a ratchet arrangement, the latch being pivotable around a pivot axis in a closing direction and in an opening direction, into an open position, a main latching position and optionally into a half-latched position, as well as into overtravel located on the other side of the main latching position, viewed from the open position, and the ratchet arrangement can be moved into at least a holding position and into a release position, the ratchet arrangement, in the holding position, keeping the latch in the main latching position, and having ratchet kinematics and an adjustable blocking element, resetting of the latch out of the main latching position in the direction of the open position causing a adjustment of the ratchet kinematics, and when the ratchet arrangement is in the holding position, the blocking element blocking this movement of the ratchet kinematics which can be caused by the latch and thus the resetting of the latch, and the ratchet kinematics or the coupling between the latch and the ratchet kinematics having a release-free mechanism such that the release-free mechanism is passed in the course of movement of the latch from the main latching position into overtravel and when the release-free mechanism is passed the latch is largely decoupled from at least part of the ratchet kinematics.

The invention also relates to a holding device for a motor vehicle safety means having a component which can be shifted out of a neutral position into an action position, having latch which fixes the component in the neutral position and acts on the holding element of the component for this purpose, and having a ratchet and latch arrangement of the type described above.

2. Description of Related Art

The motor vehicle lock under consideration comprises all types of side door locks, rear door locks, rear hatch locks, etc. Current motor vehicle locks are conventionally equipped with a lock latch and with a ratchet to implement a holding connection to a striker or the like which is located on the motor vehicle body (European Patent Application EP 0 589 158 A1). In the following, the lock latch is generally called a “latch.” The latch can be pivoted around a pivot axis, and in any case, can be moved into the main latching position. The ratchet keeps the latch in the main latching position by engaging a corresponding shape, the main catch, on the latch, with a catch projection or the like. This basic concept is also used in motor vehicle locks having a motorized opening drive, as is also shown in European Patent Application EP 0 589 158 A1.

The latch can generally be moved into an overtravel area which is located on the other side of the main latching position, viewed from the open position. Here, “overtravel” is defined as the entire pivoting region of the latch located on the other side of the main latching position. In the aforementioned motor vehicle lock, overtravel has various meanings. When the motor vehicle door assigned to the motor vehicle lock is slammed, the overtravel to a certain extent forms the runout area of the latch. In this latching process, when the main latching position is reached, the latch does not run in front of the block, but first achieves overtravel and then drops back into the main latching position. The required braking of the motor vehicle door in the closing process is then generally caused by the door seal which is located on the motor vehicle door and which builds up a seal counterpressure in the latching process.

Furthermore, in a latch equipped with a main catch, the~latch must be moved in the latching process into overtravel in order to enable engagement of the ratchet for the time being unobstructed by the main catch.

The above described motor vehicle lock having a latch and ratchet is reliable, depending on the configuration of the latch and ratchet the lifting of-the ratchet, and thus, the release of the latch is associated, in any case, with a comparatively high lifting force which is determined essentially by the friction force between the latch and ratchet during lifting of the ratchet. Against this background, an opening drive which is optionally provided must be designed to be comparatively powerful; this leads to high costs and high installation space requirement.

German Patent Application DE 103 12 304 A1, which underlies the invention, shows one approach to reducing the force necessary to release the latch from the main latching position. There, the ratchet arrangement is provided with ratchet kinematics and an adjustable blocking element, the latch being essentially dynamically coupled to the ratchet kinematics and the ratchet arrangement, and thus, the latch can be blocked by the blocking element. The blocking element of the ratchet arrangement, in terms of its function, corresponds to the ratchet used ordinarily in motor vehicle locks.

The ratchet kinematics is connected, to a certain extent, as a gearing between the latch and the blocking element. Depending on the design of the ratchet kinematics, the blocking force to be applied by the blocking element for blocking the latch can be arbitrarily reduced; this reduces the power requirements for the opening drive. The ratchet kinematics forms a reduction gearing which provides an especially high reduction ratio when the latch is in the main latching position.

The aforementioned high reduction ratio leads to a low blocking force. However, the high reduction ratio also leads to a small deflection of the latch out of the main latching position being linked to comparatively large deflections in the ratchet kinematics. This is not desirable against the background of the slamming of a motor vehicle door which is associated with high energy, in order to avoid high accelerations in the ratchet kinematics especially when overtravel is achieved. Therefore, in the known motor vehicle lock, there is a release-free mechanism which is passed in the course of movement of the latch from the main latching position into overtravel, and when passing the release-free mechanism, the latch is largely decoupled from the ratchet kinematics. The release-free mechanism is provided with pretensioning which must be overcome when the release-free mechanism is passed.

In the known motor vehicle lock, the release-free mechanism is implemented by a slot which is located in the latch and in which the pin of the ratchet kinematics runs. The pin is pretensioned against the latch via a helical spring. The disadvantage in this implementation of the release-free mechanism is, first of all, the fact that the pin which runs in the slot is fundamentally associated with high wear. Furthermore, the likewise unwanted friction between the pin and the side walls of the slot can hardly be reduced. Also, structural design of the release-free mechanism is only possible within narrow limits. The dimensioning of the pretensioning by the helical spring can also lead to problems. Overall, the implementation of the release-free mechanism with respect to the structural boundary conditions and with respect to the fundamentally unwanted wear is disadvantageous, in this case.

With respect to the holding device under consideration for a motor vehicle safety means, reference is made to German Patent Application DE 198 21 594 A1. A motor vehicle safety means is used to prevent injury to passengers in an accident or in any case to limit the hazard potential of an accident. The motor vehicle safety means can be made, for example, as a deployable roll bar, a deployable headrest, deployable knee cushion, a deployable hood, deployable bumper, deployable steering wheel or the like. The motor vehicle safety means, in an accident, is mechanically shifted into a protective position. To do this, a corresponding component of the motor vehicle safety means is moved from a neutral position, preferably suddenly, into an action position. The energy required for this purpose is provided by spring elements which can be mechanical or pneumatic. The holding device is used to fix the component in the neutral position. The requirements for this holding device correspond in essential points to the requirements for the above described motor vehicle lock. Reference should be made to the aforementioned in this regard.

### SUMMARY OF THE INVENTION

A primary object of the present invention is develop the known motor vehicle lock and the holding device such that construction limitations are reduced with a simultaneous increase of wear resistance.

This object is achieved in a motor vehicle lock of the initially mentioned type in which the ratchet kinematics has a free-running lever which can be pivoted around a pivot axis to implement the release-free mechanism, the free-running lever being pretensioned against a stop and being coupled to the latch such that passing of the release-free mechanism is associated with pivoting of the free-running lever against its pretensioning

What is important is the finding that the release-free mechanism, with respect to the overtravel of the latch, can be implemented by a free-running lever which can be pivoted around a pivot axis. Passing the release-free mechanism is associated with pivoting of the free-running lever against its pretensioning. By suitable support of the free-running lever, the friction which forms when crossing the release-free mechanism can be minimized with low construction effort. Furthermore, the mechanical characteristic of the release-free mechanism can be easily accomplished by the form of the free-running lever and by suitable dimensioning of the pretensioning. The pretensioning can be accomplished by a leg spring or the like with low construction effort.

There is a plurality of possibilities for embodying and developing this teaching of the invention as will become apparent from the detailed description below.

According to another teaching which acquires independent importance, a holding device for the motor vehicle safety means is achieved.

The component of the motor vehicle safety means, here, has a holding element with which the latch of the holding device can be caused to engage. Furthermore, there is a ratchet arrangement which keeps the latch in the main latching position. The basic structure of the aforementioned holding device is thus identical to the basic structure of the motor vehicle lock addressed above, the holding element of the component for the holding device corresponding to the striker on the motor vehicle body for the motor vehicle lock. All statements relative to the motor vehicle lock therefore fully apply accordingly to the holding device.

The invention is explained in detail below with reference to the accompanying drawings which show embodiments of the invention.

### BRIEF DESCRIPTION OF HTE DRAWINGS

FIG. 1 shows a motor vehicle lock in accordance with the invention, having a latch and ratchet arrangement in the open position,

FIG. 2 shows the motor vehicle lock according to FIG. 1 in the main latching position,

FIG. 3 shows the motor vehicle lock as shown in FIG. 1 in overtravel,

FIG. 4 shows the holding device in accordance with the invention for a motor vehicle safety means,

FIG. 5 shows a motor vehicle lock in accordance with another embodiment of the invention, having a latch and a ratchet arrangement in the main latching position.

### DETAILED DESCRIPTION OF THE INVENTION

The drawings show only the components of a motor vehicle lock and holding device which are decisive for the success of the invention. It goes without saying that all other components know to be necessary for the respective function are provided even though not shown.

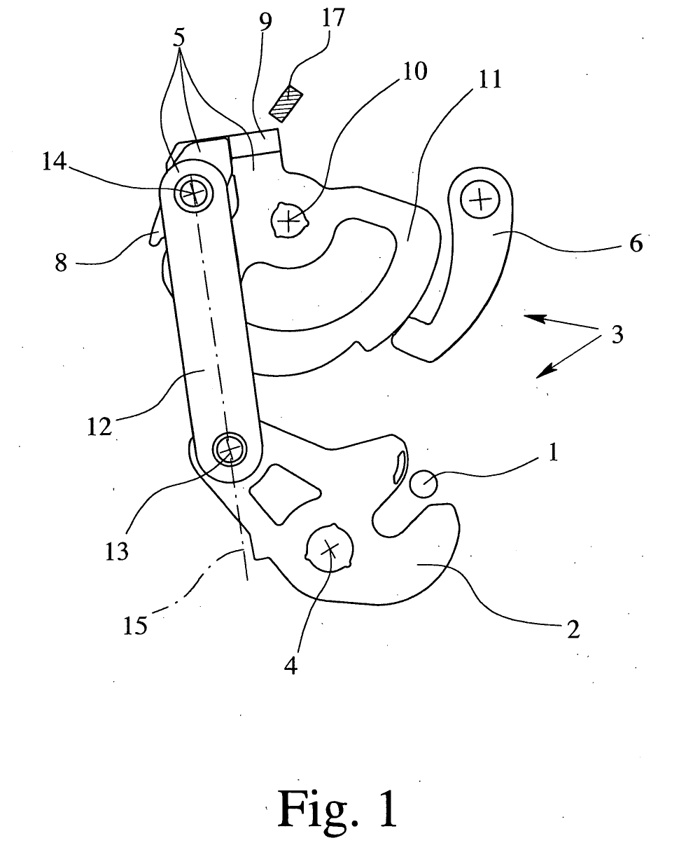

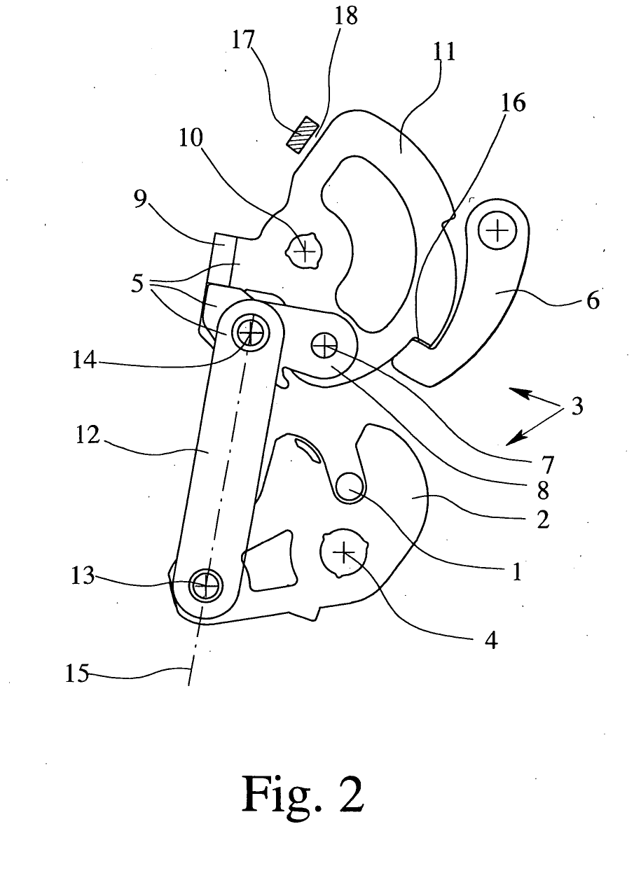

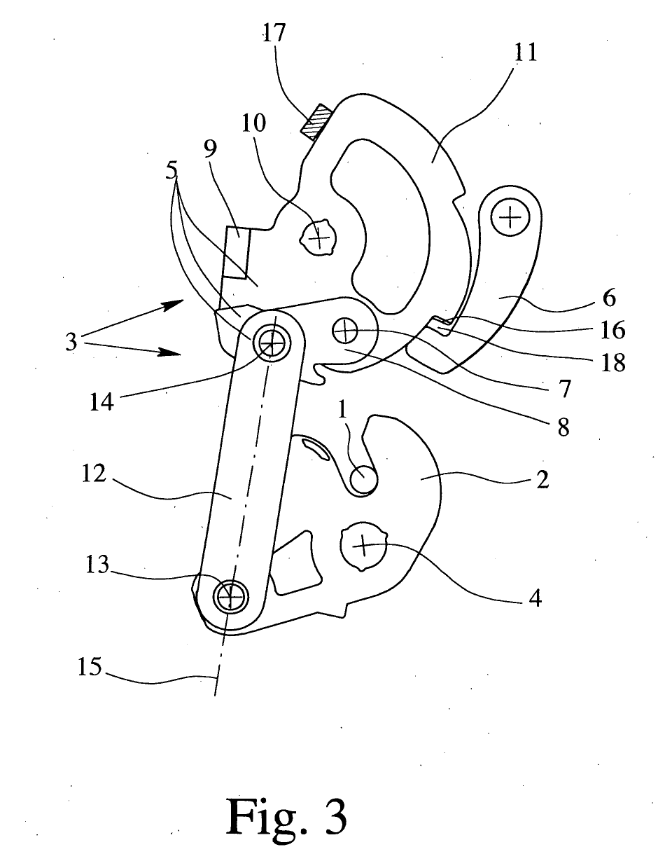

FIGS. 1 to 3 show a portion of a motor vehicle lock having a latch 2 which holds a striker 1 and having a ratchet arrangement 3. The latch 2 can be pivoted around a pivot axis 4 in a closing direction and in an opening direction, and can be moved into the open position shown in FIG. 1 and into the main latching position shown in FIG. 2. For side door locks, it is preferably provided that the latch 2 can be additionally moved into a half-latched position (not shown). Furthermore, the latch 2 can be moved into an overtravel area located on the other side of the main latching position, viewed from the open position (FIG. 3).

The ratchet arrangement 3 can be moved into the holding position shown in FIG. 2 and into the release position shown in FIG. 1. The ratchet arrangement 3, in the holding position, keeps the latch 2 in the main latching position, and if provided, in the half-latched position. Here, it can be that the ratchet arrangement 3 can be moved into a second holding position for keeping the latch 2 in the half-latched position. But it can also be that there is only a single holding position.

The ratchet arrangement 3 has ratchet kinematics 5 and an adjustable blocking element 6. Due to the coupling between the latch 2 and the ratchet kinematics 5, resetting of the latch 2 out of the main latching position shown in FIG. 2, in the direction of the open position shown in FIG. 1, causes a corresponding movement of the ratchet kinematics 5. In the illustrated embodiment, the latch 2 is essentially dynamically coupled to the ratchet kinematics 5. Here, “essentially” means that there is a still-to-be-explained release-free mechanism which partially neutralizes the dynamic coupling.

When the ratchet arrangement 3, as shown in FIG. 2, is in the holding position, the blocking element 6 blocks the aforementioned displacement of the ratchet kinematics 5 which can be caused by the latch 2, and thus, the resetting of the latch 2.

The ratchet kinematics 5 has the aforementioned release-free mechanism which is passed in the course of movement of the latch 2 from the main latching position (FIG. 2) into overtravel (FIG. 3). When the release-free mechanism is passed, the latch 2 is largely decoupled from part of the ratchet kinematics 5. The mechanical construction of the release free mechanism is explained in detail below.

So far the description corresponds essentially to the motor vehicle lock disclosed in German Patent Application DE 103 12 304 A1 and corresponding U.S. Patent Application Publication 2004/0227358. Accordingly, the contents of U.S. Patent Application Publication 2004/0227358 is hereby incorporated by reference to avoid the need to repeat that which is known therefrom.

It is important, at this point, for the ratchet kinematics 5 to have a free-running lever 8 which can be pivoted around a pivot axis 7 to implement the release-free mechanism.

The free-running lever 8 is pretensioned against a stop 9. Here, the free-running lever 8 is coupled to the latch 2 such that passing the release-free mechanism is associated with pivoting of the free-running lever 8 against its pretensioning. The advantages associated with this release-free mechanism were explained in the general part of the specification. The aforementioned implementation of a release-free mechanism with a free-running lever 8 which can be pivoted around a pivot axis 7 can be advantageously applied to all conceivable configurations of the ratchet kinematics 5.

In the preferred motor vehicle lock shown in FIGS. 1 to 3, the ratchet kinematics 5 has a transmission lever 11 which can,be pivoted around the pivot axis 10 and which is coupled to the latch 2 such that the transmission lever 11 can be adjusted by pivoting the latch 2 out of the main latching position in the direction of the open position. When the ratchet arrangement 3 is in the holding position, the blocking element 6 blocks the transmission lever 11 and thus the latch 2.

It is apparent form FIGS. 1 to 3 that the free-running lever 8 is located on the transmission lever 11 and is mounted to be able to pivot around its pivot axis 7. The stop 9 is fixed on the transmission lever 11.

To couple the transmission lever 11 to the latch 2, there is an intermediate lever 12 between these two components. Here, the intermediate lever 12 is pivotally coupled on the latch 2, on the one hand, and on the transmission lever 11 via the free-running lever 8, on the other hand, and is eccentrically coupled with regard to the respective pivot axis 4, 10. In particular, the intermediate lever 12 is coupled at the coupling point 13 to the latch 2 and at the coupling point 14 to the free-running lever 8.

When the free-running lever 8 is stationary relative to the transmission lever 11, the above described coupling between the latch 2, intermediate lever 12 and transmission lever 11 forms a four-bar mechanism by which the respectively desired reduction ratio of the ratchet kinematics 5 can be set with little construction effort.

When the latch 2 is in the main latching position, the torque on the latch 2 in the opening direction, in FIG. 2 around to the right, causes a resetting force from the latch 2 onto the ratchet kinematics 5. This resetting force is routed as compressive force to the free-running lever 8 via the intermediate lever 12, and from the free-running lever 8, via the stop 9, on the one hand, and the pivot axis 7 of the free-running lever 8, on the other hand, to the transmission lever 11. The action line 15 of this resetting force is shown in FIGS. 1 to 3. When the latch 2 is in the main latching position, the action line 15 of the force runs comparatively close past the pivot axis 10 of the transmission lever 11 so that the resulting torque acting on the transmission lever 11 is comparatively small. This torque is accommodated by the blocking element 6 which engages the main catch 16 which is located on the transmission lever 11. Accordingly, the ratchet arrangement 3 is in the holding position.

It has already been pointed out that the latch 2, especially in the latching process, can be moved into overtravel. This is the case when a torque acts on the latch 2 in the latching direction, in FIG. 2 around to the left, when the latch 2 is in the main latching position. This torque causes an overtravel force from the latch 2 onto the ratchet kinematics 5 which acts as a tensile force on the free-running lever 8 via the intermediate lever 12 and pivots the free-running lever 8 against its pretensioning. The free-running lever 8 which has been pivoted in this way is shown in FIG. 3.

The above described pivoting of the free-running lever 8 is only possible when the transmission lever 11 is hindered by some construction measure from following the entire overtravel motion of the latch 2 when the latch 2 is in the main latching position. A measure shown in FIGS. 1 to 3 calls for a stationary stop 17 for corresponding blocking of the transmission lever 11. Alternatively or additionally, it can also be provided that the transmission lever 11 is pretensioned (around to the right in FIG. 2) such that it is not entrained by the overtravel motion.

In overtravel, force transmission between the intermediate lever 12 and the transmission lever 11 does not take place via the stop 9, but solely via the free-running lever 8 or via its spring or the like which causes pretensioning.

It has already been pointed out that the blocking lever 6 corresponds with respect to its function to the ratchet of a conventional motor vehicle lock. Accordingly, the blocking lever 6 is preferably pretensioned into its blocking position, and in the latching process, engages the main catch 16 of the transmission lever 11. In order to be able to ensure reliable engagement of the blocking lever 6 in the latching process, there should also be a certain overtravel for the intermediate lever 11. FIG. 3 shows that between the blocking lever 6 and the transmission lever 11 a gap forms which allows engagement of the blocking lever 6.

The aforementioned gap 18 is formed by the transmission lever 11 having followed the overtravel motion of the latch 2 over a small pivoting region. This overtravel of the transmission lever 11 in the illustrated and preferred embodiment is limited by the stop 17. As the overtravel motion of the latch 2 continues, as described above, the free-running lever 8 is deflected.

It can be summarized that, with the above described implementation of a release-free mechanism by means of a pivoting free-running lever 8, decoupling of the latch 2 from the transmission lever 11 of the ratchet kinematics 5 is possible with a simple construction.

It has already been explained that the ratchet kinematics 5, here, is preferably a reduction gearing and that, in this way, the blocking force which is to be applied by the blocking element 6 to block the latch 2 is reduced according to the design of the reduction gearing.

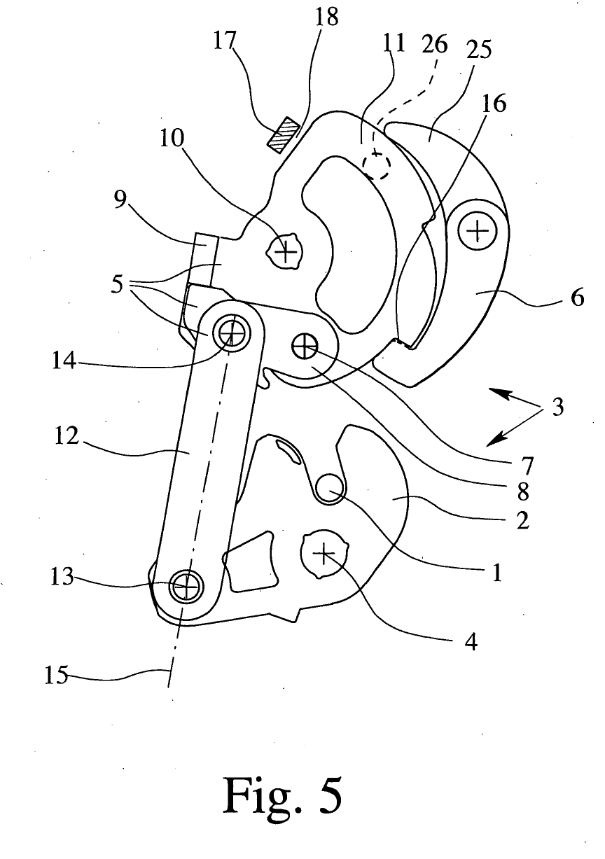

In the preferred embodiment which is shown in FIG. 5, the configuration of the blocking element 6 acquires quite special importance. The blocking element 6 here is made with two arms and it has a segment 25 on its second arm which can be caused to engage the corresponding segment 26 on the transmission lever 11. The arrangement there is such that, when the blocking element 6 is lifted, the segment 25 on the blocking element 6 engages the segment 26 on the transmission lever 11 and supports displacement of the latch 2 in the direction toward the open position. Thus, jamming of the ratchet arrangement 3 when the blocking element 6 is lifted can be largely precluded.

The twin-aRm blocking element 6 shown in FIG. 5 can be made fundamentally in one piece. However, a multipiece configuration is also usable. Then, it is preferably such that the two arms are coupled to one another via a spring arrangement. For the preferred embodiment shown in FIG. 5, the arm of the blocking element 6 which has the segment 25 is arranged so that it is offset relative to the other arm into the plane of the drawing. In this way, the segment 25 can extend behind the transmission lever 11 and engage the segment 26 (which is pin-shaped here) on the transmission element 11. Other configurations are also possible.

According to another teaching which acquires independent importance, the invention encompasses a holding device for a motor vehicle safety means 19. It has already been pointed out that the motor vehicle safety means 19 can be, for example, a deployable roll bar, a deployable headrest, deployable knee cushion, a deployable hood, deployable shock absorber, deployable steering wheel or the like. This sample listing should not be interpreted as exclusive as other applications for such a safety means will be apparent to those skilled in the art.

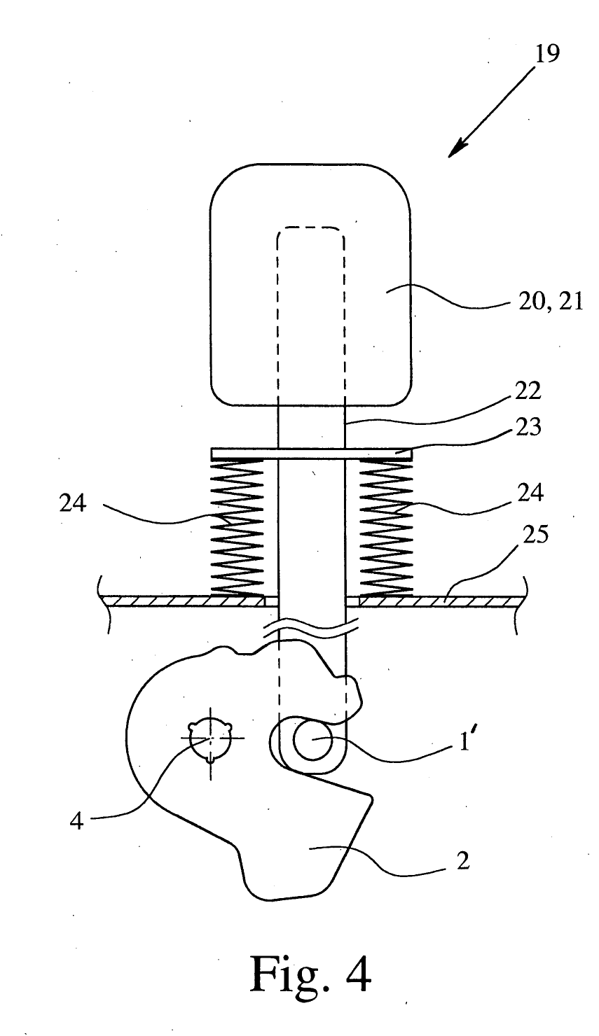

FIG. 4 shows as an example of a motor vehicle safety means 19. Motor vehicle safety means 19 comprises a headrest 20 with an integrated roll bar which is shown by the broken line. At the same time, headrest 20 forms a component 21 which can be suddenly moved out of the neutral position shown in FIG. 4 into an action position.

The component 21 of the motor vehicle safety means 19 has a support 22. In this embodiment, there is a flange 23 on the support 22 acted upon from underneath by spring assemblies 24 for suddenly moving the component 21 into its action position, here into its extended position. These spring assemblies. 24 are clamped in the neutral position of the component 21 between the flange 23 and a body-mounted abutment 25 which is only nominally shown here. The component 21 maintains its neutral position because it is held in this position by the holding device. For this purpose, the component 21 has a holding element 1′ which is located in a body-mounted inlet channel in the neutral position of the component 21 and is held there by the latch 2 of the holding device, and thus, is the counterpart of striker 1 of the vehicle lock described above. Accordingly, the structure of the holding device for a motor vehicle safety means 19 is identical to the above described motor vehicle lock insofar as the motor vehicle lock is shown in FIGS. 1 to 3. In this respect, all statements regarding the motor vehicle lock apply to the holding device accordingly.

For the holding device, the above described release-free mechanism can be provided especially for the case in which the holding device is to be transferred into the neutral position from the action position. This corresponds to the latching process for the above described motor vehicle lock.

What is claimed is:

1. Motor vehicle lock, comprising:
a latch, the latch being pivotable around a pivot axis in a closing direction and in one opening direction, for movement into at least an open position, a main latching position, and an overtravel area located on an opposite side of the main latching position from the open position;
a ratchet arrangement, the ratchet arrangement being movable into at least one holding position in which the ratchet arrangement keeps the latch in the main latching position, and into a release position, the ratchet arrangement having ratchet kinematics which are displaced during resetting of the latch out of the main latching position in the direction of the open position, and having a movable blocking element which blocks said displacement of the ratchet kinematics when the ratchet arrangement is in the holding position and thus resetting of the latch, and
a release-free mechanism which is passed by the ratchet kinematics during movement of the latch from the main latching position into the overtravel area, and which is pretensioned against a stop;
wherein the ratchet kinematics comprises a free-running lever that is pivotable around a pivot axis to activate the release-free mechanism, and wherein the free-running lever is coupled to the latch such that passing of the release-free mechanism is associated with pivoting of the free-running lever against its pretensioning.

2. Motor vehicle lock as claimed in claim 1, wherein the ratchet kinematics comprises a transmission lever which is pivotable around a pivot axis, wherein the transmission lever is displaceable by pivoting the latch out of the main latching position in the direction toward the open position, and wherein the blocking element blocks the transmission lever when the ratchet arrangement is in the holding position.

3. Motor vehicle lock as claimed in claim 2, wherein the free-running lever is located on the transmission lever and is mounted to pivot around its pivot axis.

4. Motor vehicle lock as claimed in claim 3, wherein the stop is fixed on the transmission lever.

5. Motor vehicle lock as claimed in claim 2, further comprising an intermediate lever between the transmission lever and the latch, and wherein the intermediate lever is pivotally coupled on the latch and via the free-running lever on the transmission lever eccentrically with respect to the pivot axes-of the free-running lever and transmission lever.

6. Motor vehicle lock as claimed in claim 5, wherein torque on the latch in the opening direction when the latch is in the main latching position causes a resetting force from the latch onto the ratchet kinematics, which resetting force is routed via the intermediate lever to the free-running lever and from the free-running lever via the stop and the pivot axis of the free-running lever to the transmission lever.

7. Motor vehicle lock as claimed in claim 5, wherein torque on the latch in the latching direction when the latch is in the main latching position causes an overtravel force from the latch onto the ratchet kinematics which acts on the free-running lever via the intermediate lever and pivots the free-running lever against its pretensioning.

8. Motor vehicle lock as claimed in claim 7, wherein the transmission lever is essentially stationary when the free-running lever pivots against its pretensioning.

9. Motor vehicle lock as claimed in claim 1, wherein the ratchet kinematics comprise a reduction gearing and wherein the blocking force which is applied by the blocking element to block the latch is reduced the reduction gearing.

10. Motor vehicle lock as claimed in claim 2, wherein a segment is provided on the blocking element which engages a segment provided on the transmission lever when the blocking element is lifted for supporting movement of the latch in the direction toward the open position.

11. Holding device for a motor vehicle safety means, comprising:
a component which can be shifted out of the neutral position into an action position, said component having a holding element;
a latch which fixes the component in the neutral position and acts on the holding element of the component for this purpose, the latch being pivotable around a pivot axis in a closing direction and in one opening direction, for movement into at least an open position which releases the component by releasing the holding element, a main latching position which holds the component, and an overtravel area located on an opposite side of the main latching position from the open position;
a ratchet arrangement, the ratchet arrangement being movable into at least one holding position in which the ratchet arrangement keeps the latch in the main latching position, and into a release position, the ratchet arrangement having ratchet kinematics which are displaced during resetting of the latch out of the main latching position in the direction of the open position, and having a movable blocking element which blocks said displacement of the ratchet kinematics when the ratchet arrangement is in the holding position and thus resetting of the latch, and
a release-free mechanism which is passed by the ratchet kinematics during movement of the latch from the main latching position into the overtravel area, and which is pretensioned against a stop;
wherein the ratchet kinematics comprises a free-running lever that is pivotable around a pivot axis to activate the release-free mechanism; and wherein the free-running lever is coupled to the latch such that passing of the release-free mechanism is associated with pivoting of the free-running lever against its pretensioning.

12. Holding device as claimed in claim 11, wherein the ratchet kinematics comprises a transmission lever which is pivotable around a pivot axis, wherein the transmission lever is displaceable by pivoting the latch out of the main latching position in the direction toward the open position, and wherein the blocking element blocks the transmission lever when the ratchet arrangement is in the holding position.

13. Holding device as claimed in claim 12, wherein the free-running lever is located on the transmission lever and is mounted to pivot around its pivot axis.

14. Motor vehicle lock as claimed in claim 13, wherein the stop is fixed on the transmission lever.

15. Holding device as claimed in claim 12, further comprising an intermediate lever between the transmission lever and the latch, and wherein the intermediate lever is pivotally coupled on the latch and via the free-running lever on the transmission lever eccentrically with respect to the pivot axes of the free-running lever and transmission lever.

16. Holding device as claimed in claim 15, wherein torque on the latch in the opening direction when the latch is in the main latching position causes a resetting force from the latch onto the ratchet kinematics, which resetting force is routed via the intermediate lever to the free-running lever and from the free-running lever via the stop and the pivot axis of the free-running lever to the transmission lever.

17. Holding device as claimed in claim 15, wherein torque on the latch in the latching direction when the latch is in the main latching position causes an overtravel force from the latch onto the ratchet kinematics which acts on the free-running lever via the intermediate lever and pivots the free-running lever against its pretensioning.

18. Holding device as claimed in claim 11, wherein the ratchet kinematics comprise a reduction gearing and wherein the blocking force which is applied by the blocking element to block the latch is reduced the reduction gearing.

19. Holding device as claimed in claim 12, wherein a segment is provided on the blocking element which engages a segment provided on the transmission lever when the blocking element is lifted for supporting movement of the latch in the direction toward the open position.
